(19) United States
(12) Patent Application Publication
(10) Pub. No.: US 2015/0379234 A1
(43) Pub. Date: Dec. 31, 2015

(54) MEDICINE DISPENSING APPARATUS AND METHOD

(71) Applicant: Mirza N. Baig, Woodlands, TX (US)

(72) Inventor: Mirza N. Baig, Woodlands, TX (US)

(73) Assignee: ABCD TECHNOLOGY, Woodlands, TX (US)

(21) Appl. No.: 14/316,754

(22) Filed: Jun. 26, 2014

(51) Int. Cl. G06F 19/00; A61J 7/00; B65D 83/04

(52) U.S. Cl. CPC G06F 19/3462; B65D 83/04; A61J 7/0084; B65D 2585/56

(57) ABSTRACT

A portable medicine dispensing apparatus and method includes one or more medicine dispensing units that store at least one type of medicine, and include a medicine variable display unit that identifies and labels medicines stored in each medicine dispensing unit, a database that stores data that includes medicine identifiers and a dosage information for consumption of the medicines, a user identification module that processes a user identification information and identifies a user. Each medicine dispensing unit dispenses at least one medicine to be consumed based on an input provided by the user identification information. A single receiving unit that collects one or more medicines that are dispensed by the one or more medicine dispensing units based on the input. One or more uniformly configured tubes operatively connect each of the medicine dispensing units to the single receiving unit.

### BACKGROUND

1. Technical Field

The embodiments herein generally relate to a dispensing apparatus, and more particularly to a medicine dispensing apparatus.

2. Description of the Related Art

Medicines such as pills, tablets, syrups, injections, and the like are typically packed in either strips, bottles, or any other such containers. Most patients or individuals rely upon medicines prescribed by a physicist and/or a pharmacist for the dosage information and type of medicines to be consumed for a problem, illness, or symptom. The patient has to remember each of these medicines and dosage information (e.g., time and a quantity of the medicine, etc.) at which each of these medicines has to be consumed at different interval of times for different regimens. This can result in confusion and makes it difficult for the patient or a medical assistant to remember or to keep track of the medicines and the dosage information for a prescribed course of medical treatments. Accordingly, there remains a need of a medicine dispensing apparatus that dispenses one or more appropriate medicines to be consumed at different times for different regimens.

### SUMMARY

In view of the foregoing, an embodiment herein provides a portable medicine dispensing apparatus. The portable medicine dispensing apparatus includes one or more medicine dispensing units, each medicine dispensing unit stores at least one type of medicine, and each medicine dispensing unit includes a medicine variable display unit that identifies and labels medicines stored in each medicine dispensing unit, a database that stores data associated with said medicines, a user identification module that processes a user identification information and identifies a user, a single receiving unit that collects one or more medicines that are dispensed by the one or more medicine dispensing units based on an input, and one or more uniformly configured tubes each operatively connecting each of the one or more medicine dispensing units to the single receiving unit. The data includes one or more medicine identifiers, and a dosage information for consumption of the medicines. Each medicine dispensing unit dispenses at least one medicine to be consumed based on the user identification information. At least one medicine is dispensed from at least one medicine dispensing unit from the one or more medicine dispensing units based on the input provided by said user identification information.

The medicine dispensing apparatus further include a calendar mechanism that schedules a start time and an end time for consuming the medicines, and an alert mechanism operationally linked to the calendar mechanism. The alert mechanism indicates a time for taking the at least one type of medicine. The alert mechanism may include any of a light, sound, text, video, or a combination thereof. The medicine dispensing apparatus may further include a selection unit that processes the input that indicates a selection of at least one medicine dispensing unit for dispensing a corresponding medicine.

The medicine dispensing apparatus may further include a manual input unit that enables obtaining additional medicines manually apart from a pre-programmed set of instructions, and a communication module to communicate and reset settings for dispensing the medicines. The settings are communicated and reset by the user. The user may be any of a medical professional, a pharmacist, a patient, and another individual. The medicine dispensing apparatus may further include a waterproof portable housing unit that houses the one or more medicine dispensing units, the database, and the user identification module in their entireties. The medicine dispensing apparatus may further include a cooling mechanism that cools the one or more medicine dispensing units.

In another aspect, a vending machine is provided. The vending machine includes one or more medicine dispensing units, each medicine dispensing unit stores at least one type of medicine, and each medicine dispensing unit includes a medicine variable display unit that identifies and labels medicines stored in each medicine dispensing unit, a database that stores data associated with said medicines, a user identification module that processes a user identification information and identifies a user, a single receiving unit that collects one or more medicines that are dispensed by the one or more medicine dispensing units based on an input, one or more uniformly configured tubes each operatively connecting each of the one or more medicine dispensing units to the single receiving unit, a communication module to communicate and reset settings for dispensing the medicines, and a portable housing unit that houses the one or more medicine dispensing units, the database, the user identification module, the single receiving unit, and the communication module in their entireties. The settings are communicated and reset by the user. The user is any of a medical professional, a pharmacist, a patient, and another individual. The data includes one or more medicine identifiers, and a dosage information for consumption of the medicines. Each medicine dispensing unit dispenses at least one medicine to be consumed based on the user identification information. At least one medicine is dispensed from at least one medicine dispensing unit from the one or more medicine dispensing units based on the input provided by said user identification information.

The vending machine may further include a calendar mechanism that schedules a start time and an end time for consuming the medicines, and a selection unit that processes an input comprising a selection of at least one medicine dispensing unit for dispensing a corresponding medicine. The vending machine may further include a manual input unit that enables dispensing additional medicines manually apart from a pre-programmed set of instructions, and a cooling mechanism that cools one or more medicine dispensing units.

In yet another aspect, a method of dispensing medicines using a medicine dispensing apparatus is provided. The method includes storing the medicines one or more medicine dispensing units, each medicine dispensing unit stores at least one type of medicine, identifying and labeling each medicine stored in each medicine dispensing unit, storing, in a database, data associated with the medicines, processing, using a user identification module, a user identification information and identifying a user based on said user identification information, dispensing at least one medicine from at least one medicine dispensing unit when the user is identified, collecting, in a single receiving unit, the one or more medicines that are dispensed by the one or more medicine dispensing units based on an input. Each medicine dispensing unit dispenses at least one medicine to be consumed based on the user identification information. At least one medicine is dispensed from at least one medicine dispensing unit from the one or more medicine dispensing units based on the input provided by the user identification information. The data includes one or more medicine identifiers, and a dosage information for consumption of the medicines. The medicine dispensing apparatus is portable and houses the one or more medicine dispensing units, the database, the user identification module, and the single receiving unit.

A start time and an end time may be scheduled for consuming the medicines. Settings may be reset for dispensing the medicines. The settings are communicated and reset by the user. A time for taking the at least one type of medicine may be indicated using an alert mechanism that includes any of a light, sound, text, video, or a combination thereof. An input set of instructions that include a selection of at least one medicine dispensing unit for dispensing a corresponding medicine may be processed. Additional medicines for manually dispensing may be enabled apart from a pre-programmed set of instructions. At least one of the one or more medicine dispensing units is cooled using a cooling mechanism.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1A illustrates a medicine dispensing apparatus according to an embodiment herein;

FIG. 1B illustrates the medicine dispensing apparatus of FIG. 1A according to an embodiment herein;

FIG. 2 illustrates a system block diagram of the electronic block of FIGS. 1A and 1B according to an embodiment herein;

FIG. 3 illustrates a table view of the database of FIG. 2 that stores the data according to an embodiment herein;

FIG. 4 illustrates a system block diagram of a computer component of the medicine dispensing apparatus of FIGS. 1A and 1B according to an embodiment herein; and

FIG. 5 is a flow diagram illustrating a method of dispensing the one or more medicines from the medicine dispensing apparatus of FIGS. 1A and 1B according to an embodiment herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

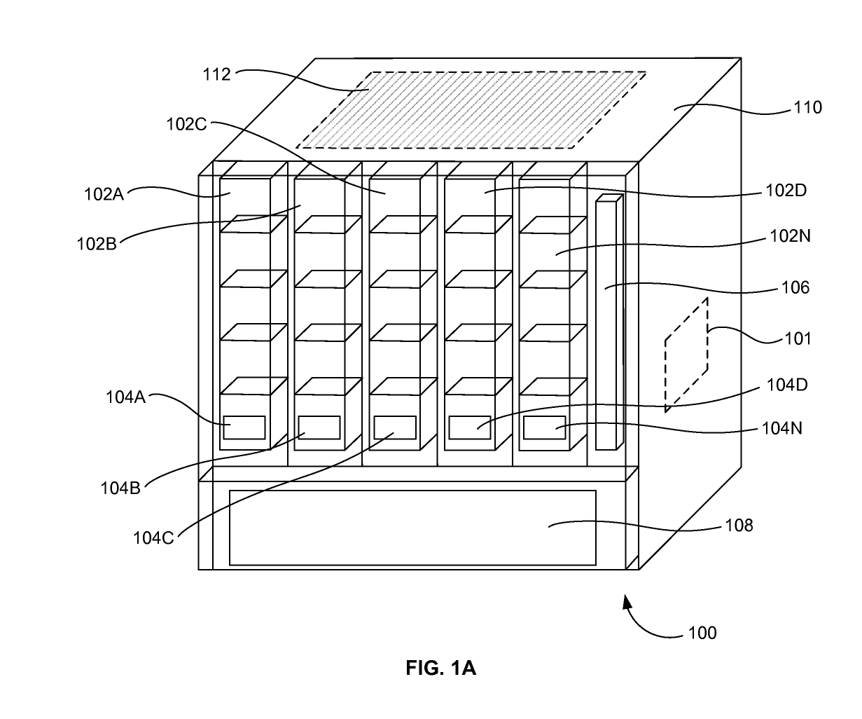

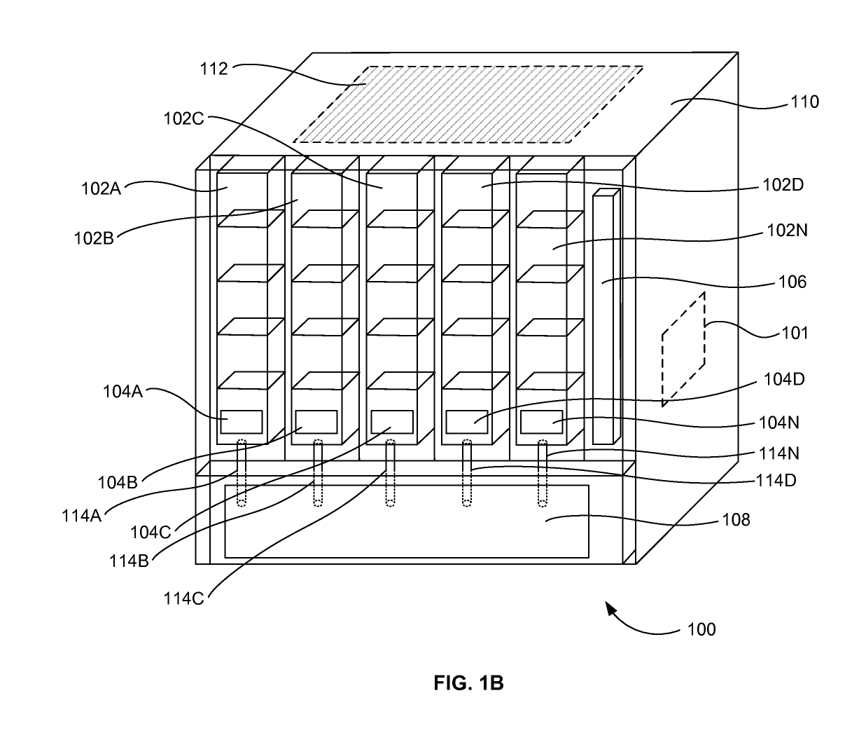

As mentioned, there remains a need for a medicine dispensing apparatus that dispenses one or more appropriate medicines to be consumed at different times for different regimens. The embodiments herein achieve this by providing a medicine dispensing apparatus that includes one or more medicine dispensing units, each storing a different medicine. Each medicine dispensing unit automatically dispenses one or more medicines to be consumed based on a programmable schedule. Referring now to the drawings, and more particularly to FIGS. 1A through 5, where similar reference characters denote corresponding features consistently throughout the figures, there are shown preferred embodiments.

FIG. 1A illustrates a medicine dispensing apparatus 100 according to an embodiment herein. The medicine dispensing apparatus 100, which may be configured like a vending machine, includes one or more medicine dispensing units 102A-N, one or more medicine variable display units 104A-N, a selection unit 106, a single receiving unit 108, and a housing 110. An electronic block 101 is located inside the medicine dispensing apparatus 100, in one example embodiment. The electronic block 101 is operatively connected to the one or more medicine dispensing units 102A-N, the one or more medicine variable display units 104A-N, the selection unit 106, the single receiving unit 108, and the housing 110. The one or more medicine dispensing units 102A-N store different medicines (not shown) that are to be accessed by a user and consumed. For example, analgesic medicines may be stored in a medicine dispensing unit 102A. Diabetic medicines may be stored in a medicine dispensing unit 102B. Vitamins may be stored in a medicine dispensing unit 102C. Anti-cold and cough medicines may be stored in a medicine dispensing unit 102D. Anti-allergic medicines may be stored in 102N, etc. The one or more medicine dispensing units 102A-N may also store medicines in fluid/liquid form such as cough syrups, etc., in one example embodiment. Moreover, the one or more medicine dispensing units 102A-N may be configured with a cooling mechanism 112 to permit a reduced temperature for medicines requiring refrigeration. In such a configuration, the one or more medicine dispensing units 102A-N may be thermally insulated to prevent the release of the reduced temperature in that particular unit. The cooling mechanism 112 cools the one or more medicine dispensing units 102A-N. The cooling mechanism 112 may be an exhaust fan, an air cooler, a holder for ice, an ice pack, or dry ice, and/or a ventilator, etc., in some example embodiments. The one or more medicine variable display units 104A-N identifies and labels the one or more medicines stored in the one or more medicine dispensing units 102A-N.

The selection unit 106 processes an input that indicates a selection of at least one medicine dispensing unit 102A-N for dispensing a corresponding medicine. The input may indicate a selection of a specific medicine to be dispensed. The input may be provided via a touch interface, a keyboard, a gesture, or any other input interface, in one example embodiment. At least one medicine that is to be consumed is dispensed by the medicine dispensing apparatus 100 based on the input. The at least one medicine is dispensed from at least one medicine dispensing unit (e.g., the medicine dispensing unit 102A) from the one or more medicine dispensing units 102A-N. Each medicine dispensing unit 102A-N may include a selection unit 106 for selecting a corresponding medicine to be dispensed from that particular medicine dispensing unit 102A-N. The single receiving unit 108 collects one or more medicines that are dispensed by the one or more medicine dispensing units 102A-N based on the input. The housing 110 may be a water proof container to house the medicine dispensing apparatus 100, in one example embodiment. The medicine dispensing apparatus 100 may be powered by a traditional AC power source (not shown) and/or may include a rechargeable or standard battery (not shown). The medicine dispensing apparatus 100 is waterproof, in one example embodiment. The medicine dispensing apparatus 100 is meant to be portable and to be used by an individual outside of a hospital setting, in a preferred embodiment.

FIG. 1B, with reference to FIG. 1A, illustrates the medicine dispensing apparatus 100 according to an embodiment herein. The medicine dispensing apparatus 100, which may be configured like a vending machine, includes one or more uniformly configured tubes 114A-N that are operatively connecting each of the one or more medicine dispensing units 102A-N to the single receiving unit 108. The one or more uniformly configured tubes 114A-N are non-funnel shaped tubes, in one example embodiment. The one or more uniformly configured tubes 114A-N may be a uniform cylindrical shape tube that acts as a chute for a medicine to fall from the one or more medicine dispensing units 102A-N to the single receiving unit 108. The medicine falls from the one or more medicine dispensing units 102A-N in a tube 114A-N may be based on gravity which does not require suction or a vacuum, in one example embodiment.

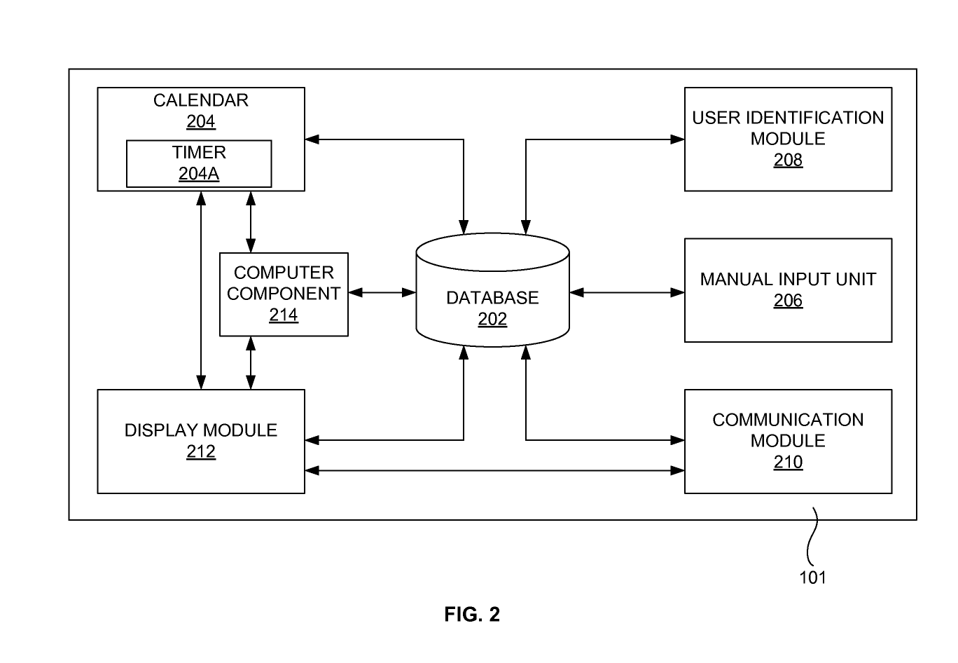

FIG. 2, with reference to FIGS. 1A and 1B, illustrates a system diagram of the electronic block 101 of FIGS. 1A and 1B according to an embodiment herein. The electronic block 101 includes a database 202, an electronic calendar 204, a timer 204A, a manual input unit 206, a user identification module 208, a communication module 210, a display module 212, and a computer component 214. The database 202 stores data associated with the medicines that are stored and/or to be stored in the one or more medicine dispensing units 102A-N. The data may include a medicine type, a problem or a symptom the medicines are used for, and/or dosage information for consumption of the medicines, etc. The dosage information may include the quantity of a medicine, and a time at which the medicine is to be consumed. The database 202 may further include information associated with a user. The one or more medicine dispensing units 102A-N and the database 202 may be completely housed in the housing 110. The user may be a medical professional, a pharmacist, a chemist, a patient, or an individual or mechanism or entity who is assisting the patient.

The calendar 204 enables scheduling a start time and an end time for consuming the medicines. The calendar 204 includes a timer 204A that is configured to alert the user. The alert may indicate a time for consuming the one or more medicines. The alert may include an audio alert from the medicine dispensing apparatus 100 or it may include communication means that presents the alert on a user's smartphone, computer, television, or provides an automated call to the user's telephone. The timer 204A may be configured with the data (e.g., medicine type, dosage information, and time of dispensing the one or more medicines from the one or more medicine dispensing units 102A-N) such that the one or more medicine dispensing units 102A-N automatically dispenses an appropriate medicine that is to be consumed. The manual input unit 206 processes an input from the user for obtaining additional medicines from the one or more medicine dispensing units 102A-N during an emergency. The manual input unit 206 further enables obtaining the additional medicines manually apart from a pre-programmed set of instructions. The user identification module 208 processes a user identification information and identifies the user based on the user identification information received from the user.

The user identification information may be a biometric, an eye scan, a patient admission/registration number, a medical assistant's identifier, or any other form of authentication and/or identifiers, etc., in some example embodiments. For example, a patient himself/herself may provide his/her identification information as an input to the user identification module 208. Upon verification of the patient's identification information, the one or more medicines that are specific to the patient's record may be dispensed from the one or more medicine dispensing units 102A-N. Similarly, when the patient is under treatment in a hospital or at his/her premises, a medical assistant's identification information (e.g., identification information of a nurse, or a medical professional, or a care taker, etc.) may be provided as an input to the user identification module 208. Upon verification of the medical assistant's identification information, the one or more medicines that are specific to the patient's record may be dispensed from the one or more medicine dispensing units 102A-N). In such scenarios, where the medical assistant provides an input, the medical assistant's identification information may be pre-configured in the medicine dispensing apparatus 100, or stored in the database 202. When the medical assistant's identification information is provided as an input and matches with a medical assistant's identification information stored in the database 202, appropriate medicines may be dispensed from the one or more medicine dispensing units 102A-N.

The communication module 210 is configured to communicate and reset one or more settings for dispensing the medicines. The settings may be reset through a Wi-Fi channel, in one example embodiment. The settings may be provided on a control panel (not shown in FIG. 2) of the medicine dispensing apparatus 100. The settings are communicated and reset by the user. The settings may be one or more configurations for (i) storing the data associated with the medicines, and the user, (ii) identifying, and labeling the medicines, and/or (iii) dispensing the one or more medicines. The settings may be reset remotely by a monitoring system (not shown) in communication with the medicine dispensing apparatus 100. Moreover, the monitoring system (not shown) may be used to monitor whether medicine has been properly dispensed at an appropriate dosage and time and whether the medicine inventory has to be replenished or whether the medicine dispensing apparatus 100 has been damaged or is not functioning properly. The display module 212 enables each medicine variable display unit 104A-N to identify and label the medicines stored in the each medicine dispensing unit (e.g., the one or more medicine dispensing units 102A-N). A LCD/LED display (not shown) may be integrated within the display module 212 to identify and label the medicines, in one example embodiment. The display module 212 further enables each medicine variable display unit 104A-N to display the data associated with at least one medicine that is dispensed from at least one medicine dispensing unit (e.g., the medicine dispensing unit 102A) for consumption. A single medicine variable display unit (e.g., 104A, for example) may be used for identifying and labeling different medicines from the one or more medicine dispensing units 102A-N, in one example embodiment.

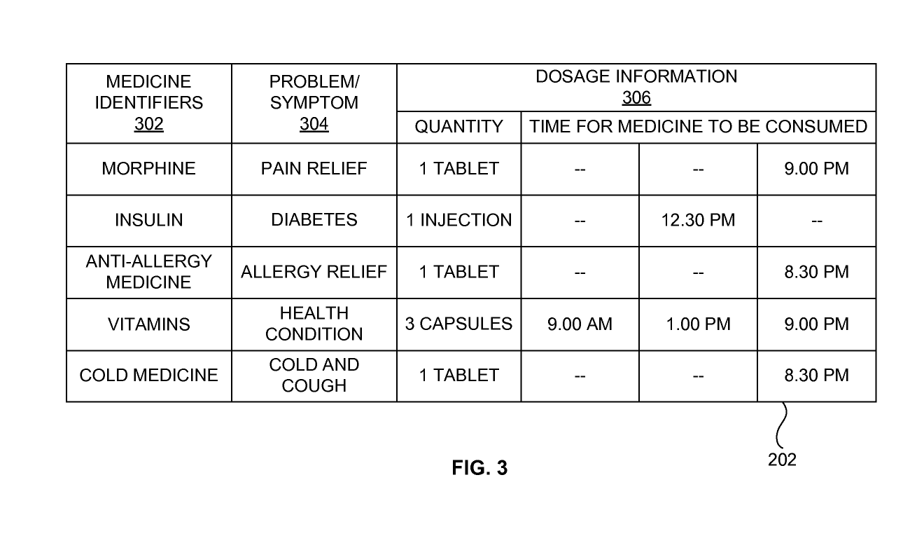

FIG. 3, with reference to FIG. 1A through 2, illustrates a table view of the database 202 of FIG. 2 that stores the data according to an embodiment herein. The database 202 includes a medicine identifiers field 302, a problem or symptom field 304, and a dosage information field 306. The dosage information field 306 includes (i) a quantity of a medicine field, and (ii) a time at which the medicine is to be consumed field. The medicine identifiers field 302 includes one or more medicines identifiers (e.g., one or more medicine names). The one or more medicines names may include morphine, insulin, anti-allergy, vitamins, and/or cold medicine, etc. The problem/symptom field 304 may include a description of a problem, illness, or symptom for which the one or more medicines are used for and/or are to be consumed. For example, for a pain relief, morphine medicines may be consumed. Similarly, for a user having diabetes, insulin may be injected into the user's body. Anti-allergy medicine may be consumed for having an allergy. Similarly, vitamins (e.g., B-complex capsules may be consumed, etc.) to improve health condition. Cold medicine may be consumed when the user has a cold and cough.

The dosage information 306 includes data related to quantity the one or more medicines to be consumed, and the time at which the one or more medicines are to be consumed. For example, 1 tablet of morphine may be consumed for pain relief at 9.00 PM. Similarly, 1 injection of insulin may be injected into the user's body before or after lunch (e.g., at 12.30 PM). 1 allergy relief tablet may be consumed at 8.30 PM. 3 capsules of vitamins (e.g., B-complex capsule) may be consumed in the morning at 9.00 AM, in the afternoon 1.00 PM, and in the evening/night at 9.00 PM. Similarly, 1 tablet of cold medicine may be consumed in the night at 8.30 PM.

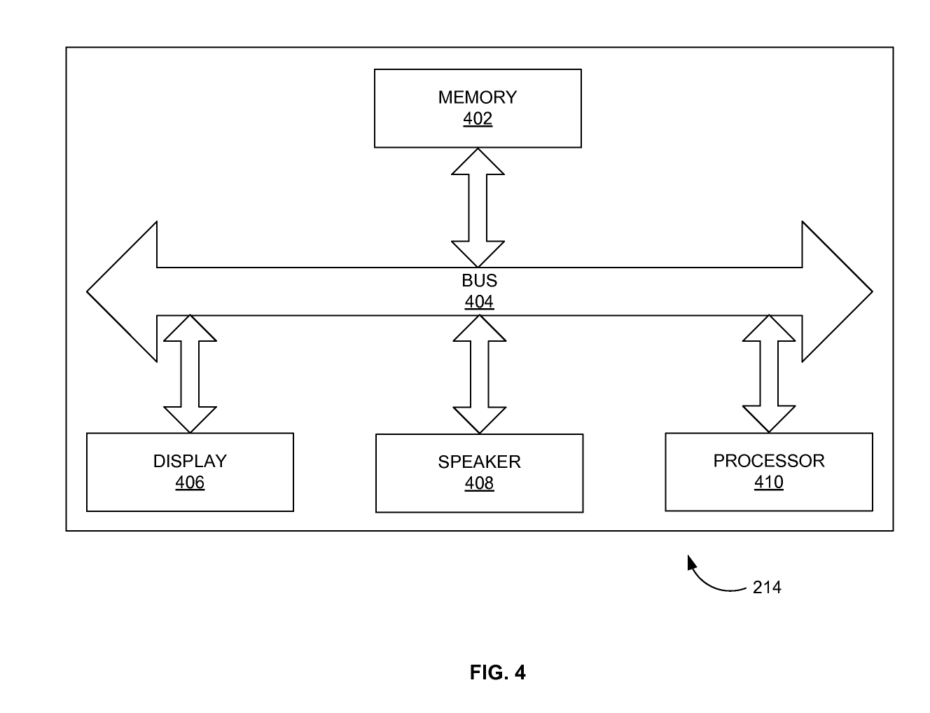

FIG. 4, with reference to FIGS. 1A through 3, illustrates a schematic diagram of the computer component 214 of the electronic block 101 of FIG. 2 of the medicine dispensing apparatus 100 of FIGS. 1A and 1B. The computer component 214 comprises a memory 402 having a set of instructions, a bus 404, a display 406, a speaker 408, and a processor 410 capable of processing a set of instructions to perform any one or more of the methodologies herein, according to an embodiment herein including using a pre-programmed set of instructions that permit the medicine dispensing apparatus 100 to dispense medicine at a pre-programmable time/date in accordance with the calendar 204. The processor 410 may also enable digital content to be consumed in the form of video for output via one or more displays 406 or audio for output via speaker and/or earphones 408. The processor 410 may also carry out the methods described herein and in accordance with the embodiments herein.

Digital content may also be stored in the memory 402 for future processing or consumption. The memory 402 includes the database 202 that stores data associated with the user, medicines, and dosage information associated with the medicines. The memory 402 may also store program specific information and/or service information (PSI/SI), including information about digital content (e.g., the detected information bits) available in the future or stored from the past. The user of the medicine dispensing apparatus 100 may view this stored information on the display 406 and select an item of for viewing, listening, or other uses via input, which may take the form of keypad, scroll, or other input device(s) or combinations thereof. When digital content is selected, the processor 410 may pass information. The content and PSI/SI may be passed among functions within the medicine dispensing apparatus 100 using the bus 404.

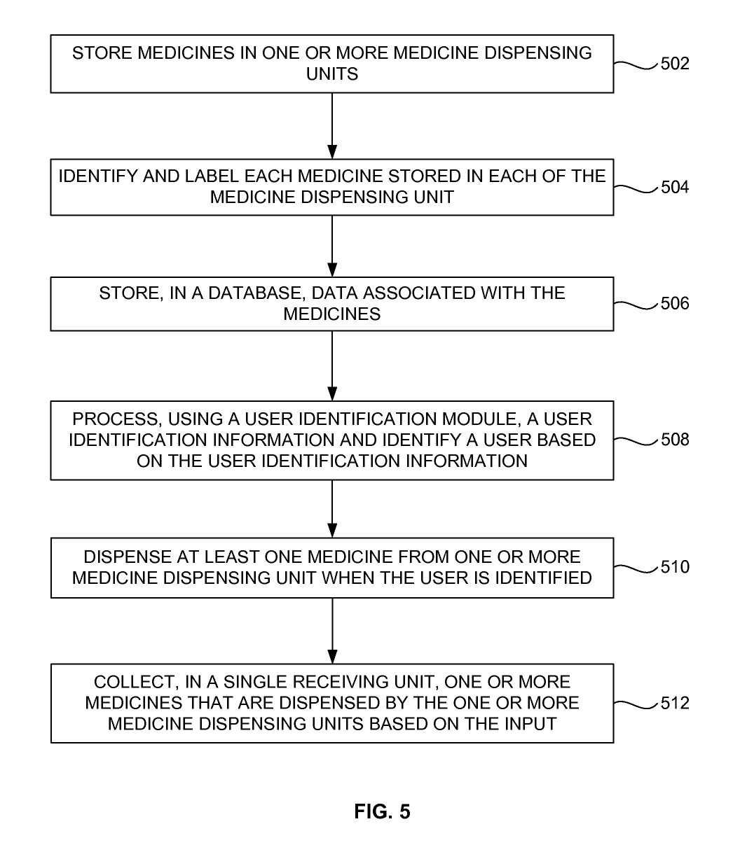

FIG. 5, with reference to FIGS. 1A through 4, is a flow diagram illustrating a method of dispensing the one or more medicines from the medicine dispensing apparatus 100 of FIG. 1A-1B according to an embodiment herein. In step 502, the medicines are stored in the one or more medicine dispensing units 102A-N. Each of the medicine dispensing units 102A-N may store at least one type of medicine. In step 504, each medicine stored in each of the medicine dispensing units 102A-N is identified and labeled. In step 506, data associated with the medicines are stored in a database 202. The data may include one or more medicine identifiers, and dosage information for consumption of the medicines. In step 508, user identification information is processed using the user identification module 208, and a user is identified based on the user identification information. In step 510, at least one medicine is dispensed from one or more medicine dispensing units 102A-N when the user is identified. Each of the medicine dispensing units 102A-N dispenses at least one medicine to be consumed based on the user identification information. The one or more medicines are dispensed from at least one medicine dispensing unit from the one or more medicine dispensing units 102A-N based on an input provided by the user identification information. In step 512, one or more medicines that are dispensed by the one or more medicine dispensing units 102A-N are collected in the single receiving unit 108 based on the input. The one or more medicines that are dispensed by the one or more medicine dispensing units 102A-N pass through the one or more uniformly configured tubes 114A-N and are collected in the single receiving unit 108, in one example embodiment. The medicine dispensing apparatus 100 is portable and houses the one or more medicine dispensing units 102A-N, the database 202, the user identification module 208, and the single receiving unit 108. A start time and an end time may be scheduled for consuming the one or more medicines. The settings may be reset for dispensing the medicines. The settings are communicated and reset by the user, in one example embodiment.

A time for taking the at least one type of medicine may be indicated using an alert mechanism. The alert mechanism may be any of a light, sound, text, video, or a combination thereof. An input set of instructions may be processed. The input set of instructions may include a selection of at least one medicine dispensing unit (e.g., 102A of FIG. 1A-1B) for dispensing a corresponding medicine. Dispensing additional medicines manually may be enabled apart from a pre-programmed set of instructions. The one or more medicine dispensing units 102A-N may be cooled using the cooling mechanism 112 of FIG. 1A-1B. The medicine dispensing apparatus 100 includes the one or more medicine dispensing units 102A-N that store different medicines. The medicine dispensing apparatus 100 is further configured with data such as medicine type, problem/symptom/illness for which the medicines are used, and dosage information, etc. The medicine dispensing apparatus 100 dispenses medicines based on the data stored in the database 202. The medicine dispensing apparatus 100 includes the communication module 210 that allows communicating and resetting one or more settings for dispensing medicines. The manual input unit 206 enables obtaining one or more medicines from the medicine dispensing units 102A-N during an emergency or for manual override. For example, the manual input unit 206 permits manual override of any pre-programmed set of instructions indicating an automated dispensing of the medicines. The medicine dispensing apparatus 100 further includes the user identification module 208 for identifying a user, and verifying an identity of the user. This prevents an unknown person from using the medicine dispensing apparatus 100.

Further, the medicine dispensing apparatus 100 includes the display module 212 that enables the medicine variable display units 104A-N to identify and label the one or more medicines to be dispensed based on an input received on the selection unit 104. For example, when the user selects a particular number (e.g., 2) on the selection unit 106 that corresponds to a particular medicine dispensing unit (e.g., the medicine dispensing unit 102B), then the display unit 104B identifies the medicine dispensing unit 102B and one or more appropriate medicines may be dispensed from the medicine dispensing unit 102B. When the display unit 104B identifies the medicine dispensing unit 102B, and labels medicines stored in the medicine dispensing unit 102B, an indicator may be displayed to the user that indicates the medicines (or a graphical image of that particular medicine) are dispensed and/or being dispensed from the medicine dispensing unit 102B for consumption. The one or more appropriate medicines that are dispensed are based on the data configured in the medicine dispensing apparatus 100.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A portable medicine dispensing apparatus, comprising:
a plurality of medicine dispensing units, wherein each medicine dispensing unit stores at least one type of medicine, and wherein said each medicine dispensing unit comprises a medicine variable display unit that identifies and labels medicines stored in said each medicine dispensing unit;
a database that stores data associated with said medicines, wherein said data comprises a plurality of medicine identifiers, and a dosage information for consumption of said medicines;
a user identification module that processes a user identification information and identifies a user, wherein said each medicine dispensing unit dispenses at least one medicine to be consumed based on said user identification information, and wherein said at least one medicine is dispensed from at least one medicine dispensing unit from said plurality of medicine dispensing units based on input provided by said user identification information;
a single receiving unit that collects one or more said medicines that are dispensed by said plurality of medicine dispensing units based on said input; and
a plurality of uniformly configured tubes each operatively connecting each of said plurality of medicine dispensing units to said single receiving unit.

2. The medicine dispensing apparatus of claim 1, further comprising a calendar mechanism that schedules a start time and an end time for consuming said medicines.

3. The medicine dispensing apparatus of claim 2, further comprising an alert mechanism operationally linked to said calendar mechanism, wherein said alert mechanism indicates a time for taking said at least one type of medicine, and wherein said alert mechanism comprises any of a light, sound, text, video, or a combination thereof.

4. The medicine dispensing apparatus of claim 1, further comprising a selection unit that processes said input that indicates a selection of at least one medicine dispensing unit for dispensing a corresponding medicine.

5. The medicine dispensing apparatus of claim 1, further comprising a manual input unit that enables obtaining additional medicines manually apart from a pre-programmed set of instructions.

6. The medicine dispensing apparatus of claim 1, further comprising a communication module to communicate and reset settings for dispensing said medicines, wherein said settings are communicated and reset by said user, and wherein said user comprises any of a medical professional, a pharmacist, a patient, and another individual.

7. The medicine dispensing apparatus of claim 1, further comprising a waterproof portable housing unit that houses said plurality of medicine dispensing units, said database, and said user identification module in their entireties.

8. The medicine dispensing apparatus of claim 1, further comprising a cooling mechanism that cools at least one of said plurality of medicine dispensing units.

9. A vending machine comprising:
a plurality of medicine dispensing units, wherein each medicine dispensing unit stores at least one type of medicine, and wherein said each medicine dispensing unit comprises a medicine variable display unit that identifies and labels medicines stored in said each medicine dispensing unit;
a database that stores data associated with said medicines, wherein said data comprises a plurality of medicine identifiers, and a dosage information for consumption of said medicines;
a user identification module that processes a user identification information and identifies a user, wherein said each medicine dispensing unit dispenses at least one medicine to be consumed based on said user identification information, and wherein said at least one medicine is dispensed from at least one medicine dispensing unit from said plurality of medicine dispensing units based on input provided by said user identification information;
a single receiving unit that collects one or more said medicines that are dispensed by said plurality of medicine dispensing units based on said input;
a plurality of uniformly configured tubes each operatively connecting each of said plurality of medicine dispensing units to said single receiving unit;
a communication module to communicate and reset settings for dispensing said medicines, wherein said settings are communicated and reset by said user, and wherein said user comprises any of a medical professional, a pharmacist, a patient, and another individual; and
a portable housing unit that houses said plurality of medicine dispensing units, said database, said user identification module, said single receiving unit, and said communication module in their entireties.

10. The vending machine of claim 9, further comprising a calendar mechanism that schedules a start time and an end time for consuming said medicines.

11. The vending machine of claim 9, further comprising a selection unit that processes an input comprising a selection of at least one medicine dispensing unit for dispensing a corresponding medicine.

12. The vending machine of claim 9, further comprising a manual input unit that enables dispensing additional medicines manually apart from a pre-programmed set of instructions.

13. The vending machine of claim 9, further comprising a cooling mechanism that cools at least one of said plurality of medicine dispensing units.

14. A method of dispensing medicines using a medicine dispensing apparatus, said method comprising:
storing said medicines in a plurality of medicine dispensing units, wherein each medicine dispensing unit stores at least one type of medicine;
identifying and labeling each medicine stored in said each medicine dispensing unit;
storing, in a database, data associated with said medicines, wherein said data comprises a plurality of medicine identifiers, and a dosage information for consumption of said medicines;
processing, using a user identification module, a user identification information and identifying a user based on said user identification information;
dispensing at least one medicine from at least one medicine dispensing unit when said user is identified, wherein said each medicine dispensing unit dispenses at least one medicine to be consumed based on said user identification information, and wherein said at least one medicine is dispensed from at least one medicine dispensing unit from said plurality of medicine dispensing units based on input provided by said user identification information; and
collecting, in a single receiving unit, one or more said medicines that are dispensed by said plurality of medicine dispensing units based on said input,
wherein said medicine dispensing apparatus is portable and houses said plurality of medicine dispensing units, said database, said user identification module, and said single receiving unit.

15. The method of claim 14, further comprising scheduling a start time and an end time for consuming said medicines.

16. The method of claim 14, further comprising resetting settings for dispensing said medicines, wherein said settings are communicated and reset by said user.

17. The method of claim 14, further comprising indicating a time for taking said at least one type of medicine using an alert mechanism comprising any of a light, sound, text, video, or a combination thereof.

18. The method of claim 14, further comprising processing an input set of instructions comprising a selection of at least one medicine dispensing unit for dispensing a corresponding medicine.

19. The method of claim 14, further comprising enabling dispensing additional medicines manually apart from a pre-programmed set of instructions.

20. The method of claim 14, further comprising cooling at least one of said plurality of medicine dispensing units.
